(19) United States
(12) Patent Application Publication
(10) Pub. No.: US 2008/0190987 A1
(43) Pub. Date: Aug. 14, 2008

(54) Driver Guiding Set for Power Nail Gun

(76) Inventor: Po-Feng Huang, Taipei Hsien (TW)

Correspondence Address: HDSL, 4331 STEVENS BATTLE LANE, FAIRFAX, VA, 22033, US

(21) Appl. No.: 11/675,081

(22) Filed: Feb. 14, 2007

(51) Int. Cl. B27F 7/05

(52) U.S. Cl. 227/109

(57) ABSTRACT

A driver guiding set for a power nail gun includes a forward plate fixedly disposed at a bottom portion of a gun body of the power nail gun, a first rearward plate fixedly disposed at the forward plate, a first magazine rail fixed to the first rearward plate, a second magazine rail slidably disposed on the first magazine rail, and a second rearward plate fixedly disposed on the second magazine rail. A nail guiding track is disposed between the first and second rearward plates, which is switched in one of the status of parting and locking. When the second rearward plate contacts with the forward plate and the first rearward plate to lock the nail guiding track, the nail guiding track can induce a striking blade to strike the nail in the nail guiding track. When the second rearward plate moves far away form the forward plate and the first rearward plate to part the nail guiding track, the nail guiding track will be lifted, then the user can conveniently remove the nail locked in the nail guiding track.

### BACKGROUND

The present invention relates to power driving tools, and more particularly to a driver guiding set for a power nail gun. The power nail gun includes a rearward plate having a movable member and a fixing member, and the magazine is opened or closed by the movable member of the rearward plate.

Power nail gun can uses gas fuel, compressed high pressure air or electric power a power source to drive a striking blade to strike a nail, for join two objects by actuating a nail guided in a magazine through both objects, which are widely used in woodworking. Generally, the magazine is disposed at a bottom portion of the nail gun, and between a forward plate and a rearward plate thereof. Actuating nails of a nail gun generally can be divided into two types: sequential actuation mode and contact actuation mode.

Nowadays, an improved magazine of the nail gun is capable of being opened and closed freely, for example, U.S. Pat. No. 5,368,213 disclosed a kind of this magazine. The magazine is disposed on a forward plate at a bottom portion of the nail gun, and the nail gun includes a movable rearward plate, a fixed rearward plate. When the movable rearward plate contacts with the forward plate and the fixed rearward plate, the magazine is closed, which induces the striking blade to strike the nail in the magazine. In addition, when the movable rearward plate move away from the forward plate and the fixed rearward plate, the magazine is opened, then the user can remove the nail locking in magazine.

The magazine includes a side wall protruding from a side of a bottom portion of an entrance thereof, and the side wall is used to guide the nail aligned in the magazine to be stroked by the striking blade one by one. However, when the user open the magazine and remove the locked nail therein, the protruding side wall will block the entrance of the magazine, which makes the operation of removing the locked nails in the magazine unduly burdensome.

Accordingly, what is needed is a magazine for a nail gun that can overcome the above-described deficiencies.

### BRIEF SUMMARY

A driver guiding set for a power nail gun, which is capable of forming a nail guiding track to induce a striking blade to strike the nail in the nail guiding track when a magazine is in a locking status, and lifting the nail guiding track when the magazine is parted, for conveniently removing the nail locked in the nail guiding track.

The nail gun includes a gun body; a striking blade, which is capable of being driven to extend out of the gun body; a forward plate fixedly disposed at a bottom portion of the gun body for supporting a side of the striking blade; a first rearward plate fixedly disposed between the forward plate and the gun body for supporting another side of the striking blade; a first magazine rail fixed to the first rearward plate; a second magazine rail slidably disposed on the first magazine rail; and a second rearward plate fixedly disposed on the second magazine rail. The second rearward plate includes a first position contacted with the forward plate and the first rearward plate, and a second position far away from the forward plate and the first rearward plate. The second rearward plate is capable of sliding between the first and second positions.

Moreover, a nail guiding track is disposed between the first and second rearward plates, and which is switched in one of the status of parting and locking. The first rearward plate further includes a protruding side wall disposed at a bottom side of the first rearward plate, and adjacent to an entrance of the nail guiding track.

With these configurations, when the second rearward plate contacts with the forward plate and the first rearward plate to lock the nail guiding track, the side wall can guide a nail into the nail guiding track, then the nail guiding track can induce a striking blade to strike the nail in the nail guiding track. When the second rearward plate moves far away form the forward plate and the first rearward plate to part the nail guiding track, the nail guiding track will be lifted and the side wall will be opened, then the user can conveniently remove the nail locked in the nail guiding track.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is an exploded, perspective view of a driver guiding set according to an exemplary embodiment of the present invention;

FIG. 2 is a front, assembled view of the driver guiding set of FIG. 1;

FIG. 3 is an isometric view of the driver guiding set of FIG. 2, showing an operating status of the magazine;

FIG. 4 is an assembled view of a first rearward plate and a second rearward plate of the driver guiding set of the present invention;

FIG. 4a is a cross-sectional view taken alone line 4a-4a of FIG. 4, showing an operating status of the rearward plates;

FIG. 4b is a cross-sectional view taken alone line 4a-4a of FIG. 4, showing another operating status of the rearward plates;

FIG. 5 is an enlarged view of part of the first rearward plate of the driver guiding set of the present invention;

FIG. 6 is a cross-sectional view of a first and a second magazine rails of the driver guiding set of the present invention;

FIG. 7 is another cross-sectional view of the first and second magazine rails of the driver guiding set of the present invention;

FIG. 8 is further another cross-sectional view of the first and second magazine rails of the driver guiding set of the present invention;

FIG. 9 is further another cross-sectional view of the first and second magazine rails of the driver guiding set of the present invention;

FIG. 10 is a cross-sectional view of part of the driver guiding set of the present invention, showing an operating status thereof;

FIG. 11 is a cross-sectional view of part of the first and second rearward plate of the driver guiding set, showing an operating status thereof;

FIG. 12 is a schematic view of the first and second rearward plate of the driver guiding set, showing an operating status thereof;

FIG. 13 is a schematic view of part of the driver guiding set, showing an operating status thereof;

FIG. 14 is another cross-sectional view of part of the first and second rearward plate of the driver guiding set, showing an operating status thereof;

FIG. 15 is an enlarged view of part of the driver guiding set of FIG. 13;

FIG. 16 is schematic view of the first rearward plate, showing an operating status thereof; and

FIG. 17 is further another cross-sectional view of part of the first and second rearward plate of the driver guiding set, showing an operating status thereof.

### DETAILED DESCRIPTION

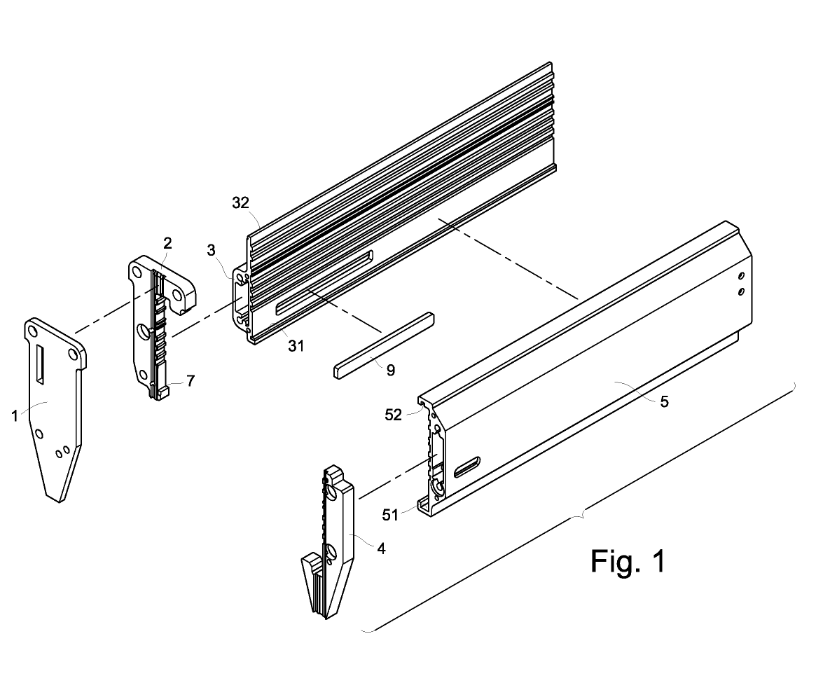

Referring to FIG. 1, an exploded, perspective view of a driver guiding set for a power nail gun according to an exemplary embodiment of the present invention is shown. The nail gun includes a gun body, a striking blade 10 which is capable of being driven to extend out of the gun body (as shown in FIG. 12), a forward plate 1 fixedly disposed at a bottom portion of the gun body for supporting a side of the striking blade 10, a first rearward plate 2 fixedly disposed between the forward plate 1 and the gun body for supporting another side of the striking blade 10, a first magazine rail 3 fixed to the first rearward plate 2, a second magazine rail 5 slidably disposed on the first magazine rail 3, and a second rearward plate 4 fixedly disposed on the second magazine rail 5.

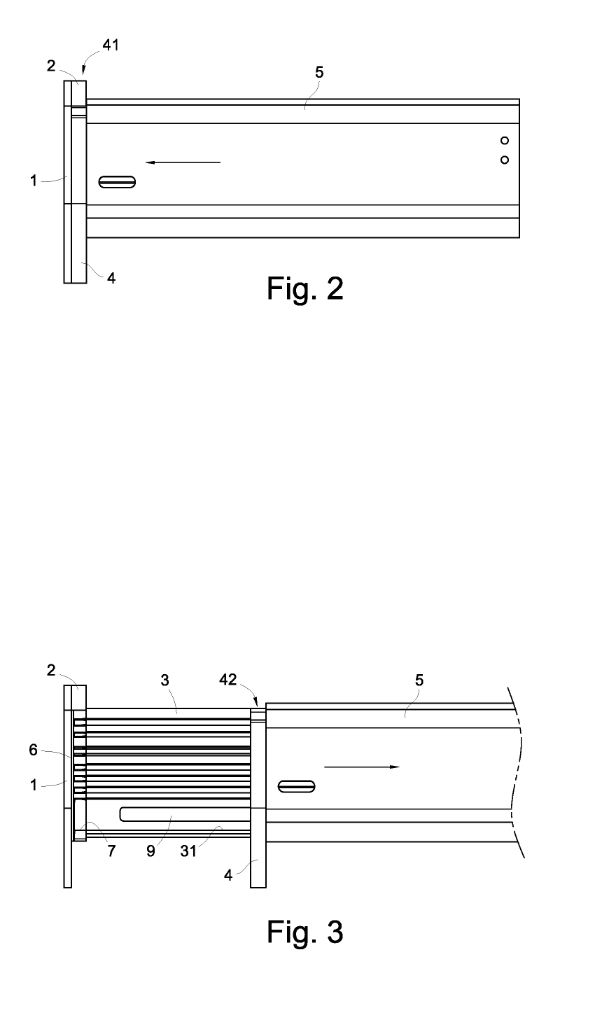

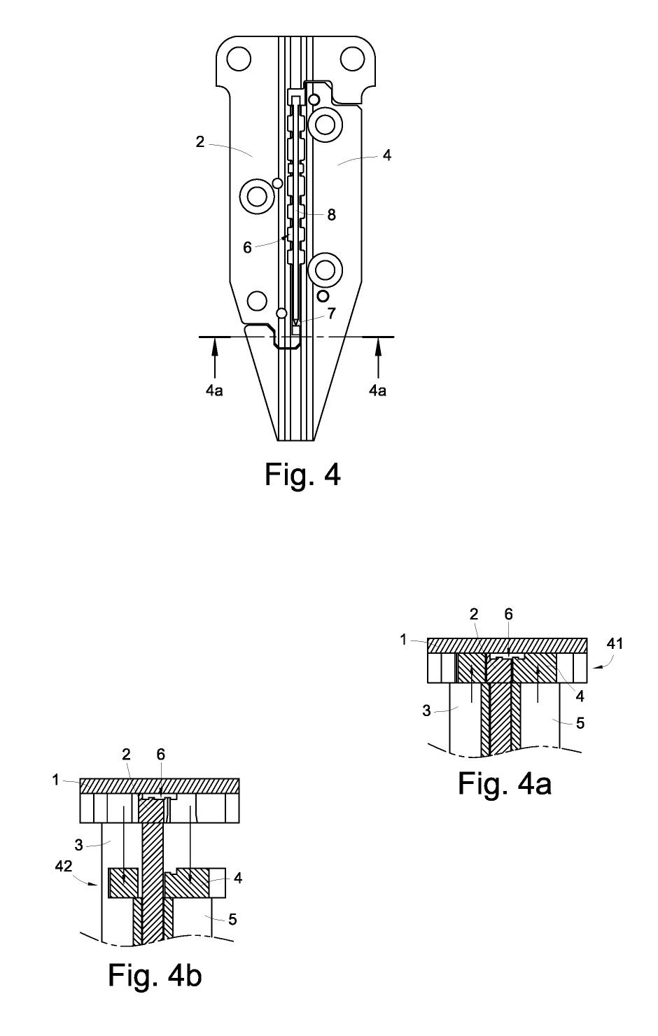

The second rearward plate 4 includes a first position 41 (as shown in FIGS. 2 and 4a) contacted with the forward plate 1 and the first rearward plate 2, and a second position 42 (as shown in FIGS. 3 and 4b) far away from the forward plate 1 and the first rearward plate 2. The second rearward plate 4 is capable of sliding between the first and second positions 41 and 42.

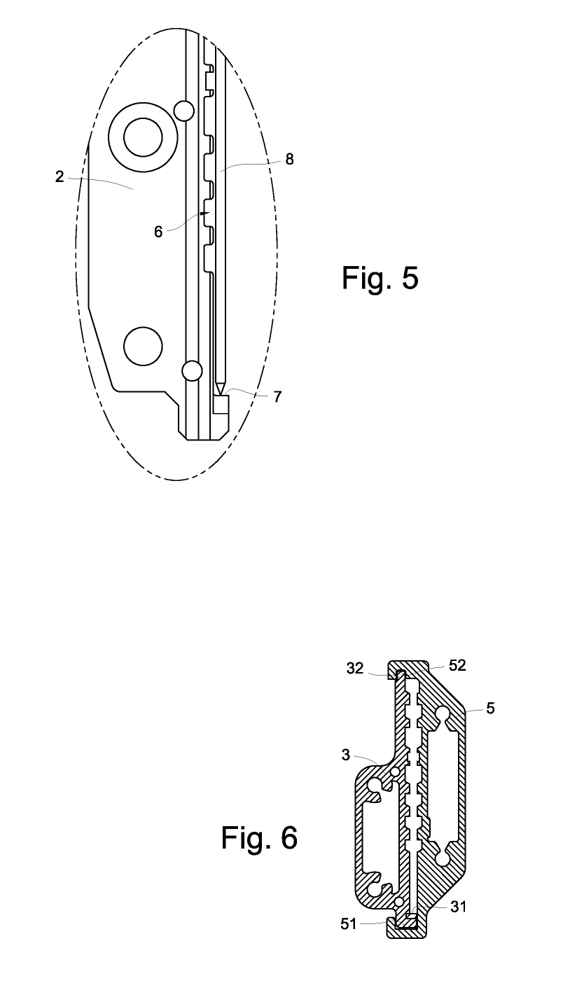

Moreover, a nail guiding track 6 is disposed between the first and second rearward plates 2 and 4 (as shown in FIGS. 4, 4a, and 4b), which is switched in one of the status of parting and locking. The first rearward plate 2 further includes a protruding side wall 7 (as shown in FIGS. 1, 3 and 5) disposed at a bottom side of the first rearward plate 2, and adjacent to an entrance of the nail guiding track 6, which can guide the nail 8 into the nail guiding track 6. The first magazine rail 3 includes a rib wall 31 (as shown in FIGS. 1, 3 and 6) disposed at a bottom side thereof so that the protruding side wall 7 is matched with the rib wall 31 as being extended therefrom after the first rearward plate 2 is engaged with the first magazine rail 3.

Various modifications and alterations are possible within the ambit of the assembled manner herein.

Referring to FIG. 6, the second magazine rail 5 forms an upwardly opened down slide track 51 at a bottom portion thereof for receiving and mating with a peripheral of the rib wall 31 of the first magazine rail 3, and a downwardly opened up slide track 52 at a top portion thereof for receiving and mating with a slide arm 32 disposed at a top portion the first magazine rail 3.

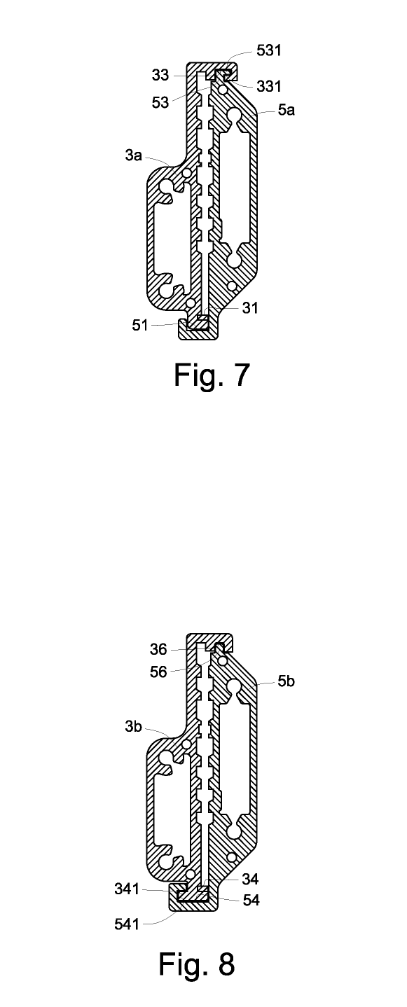

Referring to FIG. 7, the second magazine rail 5a forms an upwardly opened down slide track 51 at a bottom portion thereof for receiving and mating with a peripheral of the rib wall 31 of the first magazine rail 3a. The first magazine rail 3a forms a downwardly opened up slide track 33 at a top portion thereof, and the second magazine rail 5a forms an up slide arm 53 being received and mated with the up slide track 33. A rib track 331 is formed at a contract surface between the up slide track 33 and the up slide arm 53, and a rib 531 is disposed in the rib track 331.

Referring to FIG. 8, the second magazine rail 5b forms an upwardly opened down slide track 54 at a bottom portion thereof for receiving and mating with a peripheral of the rib wall 34 of the first magazine rail 3b. A rib track 541 is formed at a contract surface between the down slide track 54 and the rib wall 34, and a rib 341 is disposed in the rib track 541. The first magazine rail 3b forms a downwardly opened up slide track 36 at a top portion thereof, and the second magazine rail 5b forms an up slide arm 56 being received and mated with the up slide track 36.

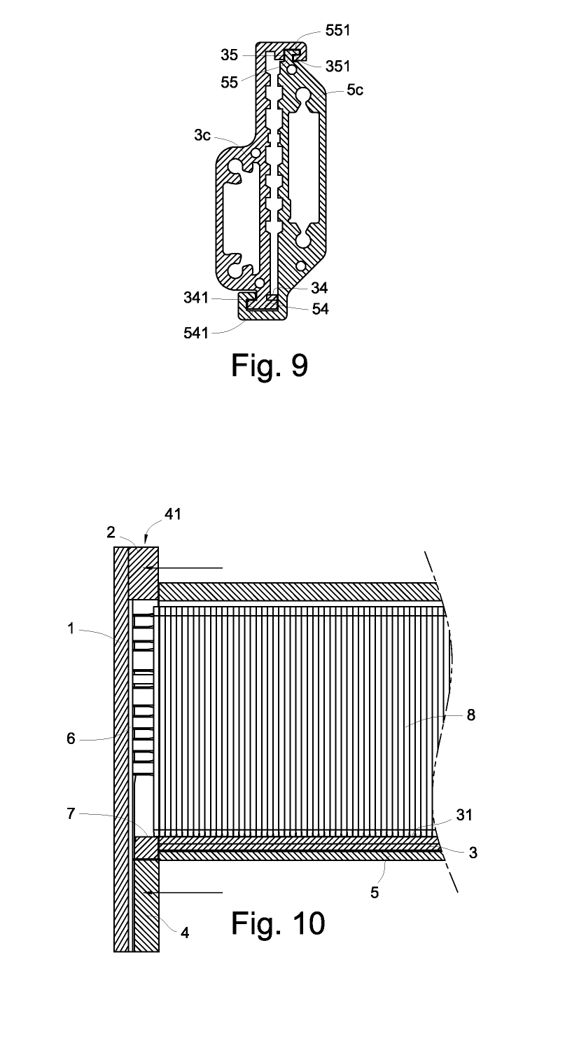

Referring to FIG. 9, the second magazine rail 5c forms an upwardly opened down slide track 54 at a bottom portion thereof for receiving and mating with a peripheral of the rib wall 34 of the first magazine rail 3c. A rib track 541 is formed at a contract surface between the down slide track 54 and the rib wall 34, and a rib 341 is disposed in the rib track 541. The first magazine rail 3c forms a downwardly opened up slide track 35 at a top portion thereof, and the second magazine rail 5c forms an up slide arm 55 being received and mated with the up slide track 35. A rib track 351 is formed at a contract surface between the up slide track 35 and the up slide arm 55, and a rib 551 is disposed in the rib track 351.

All of the assembled manner of the rib track 331, 351 and 541 as well as the rib 531, 341 and 551 above-mentioned of FIGS. 7, 8 and 9 can prevent the second magazine rail 5a, 5b and 5c from becoming flexible and falling off away from the first magazine rail 3a, 3b and 3c, respectively.

Furthermore, a magnet 9 is disposed at an inner side of the first magazine rail 3, 3a, 3b and 3c (as shown in FIGS. 1 and 2), for absorbing the plurality of nails 8 containing and aligning in the first magazine rail 3, 3a, 3b and 3c, and prevent the nails 8 from falling off.

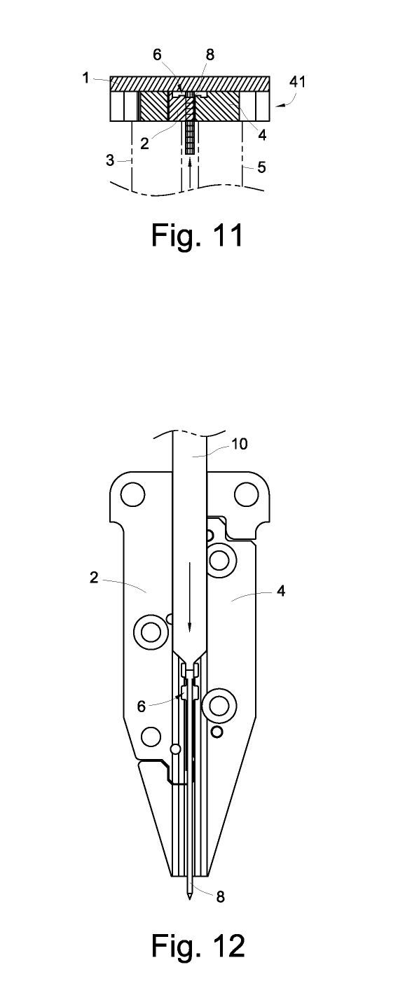

In use, before nailing the working objects, the user can move the second rearward plate 4 to the first position 41 (as shown in FIGS. 10 and 11), to lock the nail guiding track 6. At this time, the rib wall 31 of the first magazine rail 3 will guide the nails 8 disposed between the first and second magazine rails 3 and 5 into the nail guiding track 6 one by one via the protruding side wall 7. Then, the nail guiding track 6 can induce the striking blade 10 (as shown in FIG. 12) to strike the nail 8 in the nail guiding track 6.

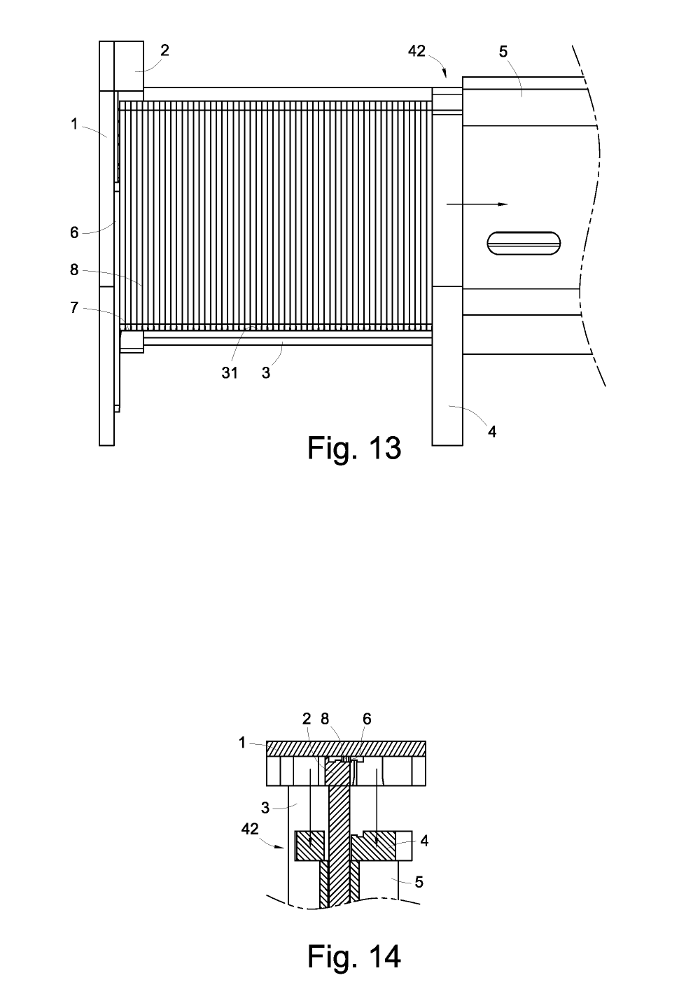

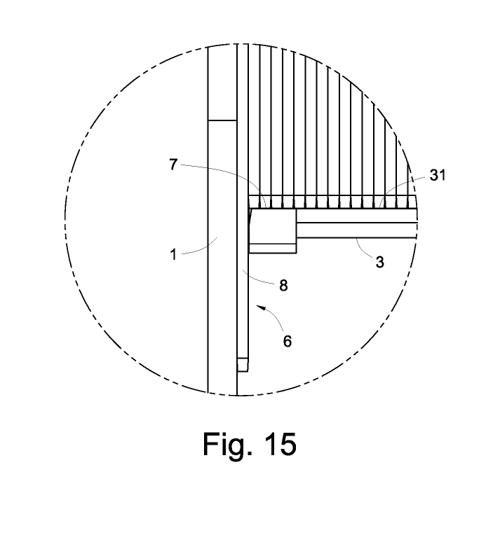

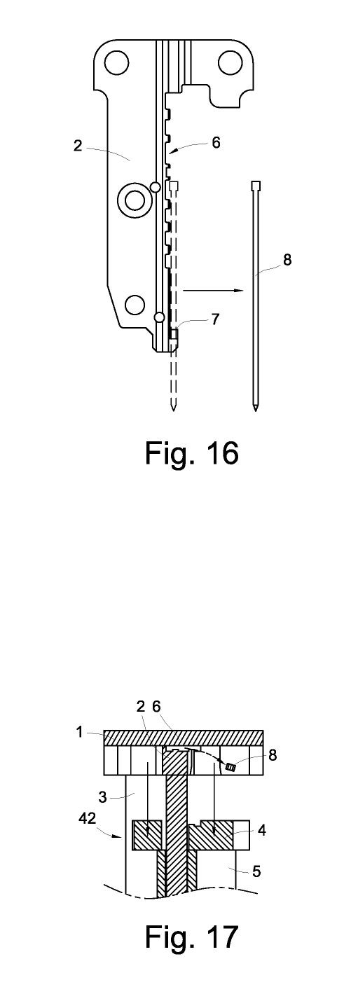

If the nail 8 is locked in the nail guiding track 6 during the striking process, the user can move the second rearward plate 4 to the second position 42 (as shown in FIGS. 13 and 14), to part the nail guiding track 6. In other words, the nail guiding track 6 is lifted, half of which is bared to environment (as shown in FIGS. 15 and 16). At this time, the protruding side wall 7 is also opened, and the user can conveniently remove the nail 8 locked in the nail guiding track 6 (as shown in FIG. 17). That is, the facility of failure treatment of the nail gun is improved.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

1. A driver guiding set for a power nail gun which has a gun body and a striking blade capable of being driven to extend out of the gun body, the driver guiding set comprising:
a forward plate fixedly disposed at a bottom portion of the gun body for supporting a side of the striking blade;
a first rearward plate fixedly disposed between the forward plate and the gun body for supporting another side of the striking blade;
a first magazine rail fixed to the first rearward plate;
a second magazine rail slidably disposed on the first magazine rail;
a second rearward plate fixedly disposed on the second magazine rail, the second rearward plate comprising a first position contacted with the forward plate and the first rearward plate, and a second position far away from the forward plate and the first rearward plate, the second rearward plate being capable of sliding between the first and second positions; and
a nail guiding track formed between the first and second rearward plate as the second rearward plate at the first position, and which being capable of switching in one of the status of parting and locking as the second rearward plate at the second and the first positions, respectively,
wherein when the second rearward plate is moved to the first position to form the nail guiding track, the striking blade is induced to strike the nail in the nail guiding track; when the second rearward plate is moved to the second position to part the nail guiding track, the nail guiding track is opened, and a nail locked in the nail guiding track is capable of being removed.

2. The driver guiding set as claimed in claim 1, wherein the first rearward plate comprises a protruding side wall disposed at a bottom side of the first rearward plate, and adjacent to an entrance of the nail guiding track, the protruding side wall guides nails into the nail guiding track when the nail guiding track being locked and is opened when the nail guiding track being parted.

3. The driver guiding set as claimed in claim 2, wherein the first magazine rail comprises a protruding rib wall disposed at a bottom side thereof, so that the protruding side wall is matched with the protruding rib wall as being extended therefrom after the first rearward plate is engaged with the first magazine rail, and the rib wall guides the nails disposed between the first and second magazine rails into the nail guiding track one by one via the protruding side wall.

4. The driver guiding set as claimed in claim 3, wherein the second magazine rail forms an upwardly opened down slide track at a bottom portion thereof for receiving and mating with a peripheral of the rib wall of the first magazine rail.

5. The driver guiding set as claimed in claim 4, further comprising a rib track formed at a contract surface between the down slide track and the rib wall, and a rib disposed in the rib track.

6. The driver guiding set as claimed in claim 3, wherein the second magazine rail forms a downwardly opened up slide track at a top portion thereof, and the first magazine rail forms an up slide arm being received and mated with the up slide track.

7. The driver guiding set as claimed in claim 3, wherein the first magazine rail forms a downwardly opened up slide track at a top portion thereof, and the second magazine rail forms an up slide arm being received and mated with the up slide track.

8. The driver guiding set as claimed in claim 6, further comprising a rib track formed at a contract surface between the up slide track and the up slide arm, and a rib disposed in the rib track.

9. The driver guiding set as claimed in claim 7, further comprising a rib track formed at a contract surface between the up slide track and the up slide arm, and a rib disposed in the rib track.
